(19) United States
(12) Patent Application Publication
(10) Pub. No.: US 2026/0264782 A1
(43) Pub. Date: Sep. 10, 2026

(54) Modular Canopy Assembly System

(71) Applicants: Hyundai Motor Company, Seoul (KR); Kia Corporation, Seoul (KR)

(72) Inventors: Robert Gibbs, Superior Township, MI (US); Pablo Guiterrez, Superior Township, MI (US); Richard Maciejewski, Superior Township, MI (US); Meghan Mojica, Superior Township, MI (US)

(21) Appl. No.: 19/071,347

(22) Filed: Mar. 5, 2025

(51) Int. Cl. B62D 63/02; B60J 7/10

(52) U.S. Cl. CPC B62D 63/025; B60J 7/106

(57) ABSTRACT

A modular canopy system is provided. The modular canopy system may comprise a roof panel assembly, a rear panel assembly, and two side panel assemblies. The two side panel assemblies may be configured to be removably secured to a vehicle. The rear panel assembly may be configured to be removably secured to the two side panel assemblies. The roof panel assembly may be configured to be removably secured to the two side panel assemblies and the rear panel assembly, forming a canopy over a portion of the vehicle.

### BACKGROUND

### Technical Field

Embodiments of the present disclosure relate to canopy assembly systems and, more particularly, a modular canopy assembly system.

### Background

Canopies are large pieces of material that cover the back of vehicle. Canopies come with or without separate front pieces and often cover the storage compartments of vehicles.

There is a market for SUVs having a rugged appearance. Part of this appeal comes from the inclusion of detachable hard-top rear canopies/roof panels. These detachable canopies/roof panels allow for an “open air” driving experience. However, these detachable canopies/roof panels are often bulky and difficult to assemble and remove from the vehicle, decreasing user satisfaction.

Competitive rugged SUVs utilize after-market solutions for special storage of the rear canopy/roof panel. However, this requires the purchase of specialized racks and shelving for storing hard-top canopies properly. This results in the customer being left with a lack of storage space when storing both the canopy and rack for holding the canopy. Without the special equipment, removing and re-attaching the canopy is not a straightforward process for the customer, and is often a two-person job to remove/assemble the rear canopy when not using assistive equipment.

For at least these reasons, canopy assemblies and storage solutions that allow for easier assembly and accessible storage are needed.

### SUMMARY

According to an object of the present disclosure, a modular canopy system is provided. The modular canopy system may comprise a roof panel assembly, a rear panel assembly, and two side panel assemblies. The two side panel assemblies may be configured to be removably secured to a vehicle. The rear panel assembly may be configured to be removably secured to the two side panel assemblies. The roof panel assembly may be configured to be removably secured to the two side panel assemblies and the rear panel assembly, forming a canopy over a portion of the vehicle.

According to an exemplary embodiment, the modular canopy system may comprise a magnetic locking system. The roof panel assembly may be configured to be removably secured to the two side panel assemblies and the rear panel assembly via the magnetic locking system.

According to an exemplary embodiment, the magnetic locking system may comprise one or more: magnetic locating mechanisms; and one or more mounting plates.

According to an exemplary embodiment, the one or more magnetic locating mechanisms may comprise one or more magnets.

According to an exemplary embodiment, the one or more magnets may be attracted to the one or more mounting plates.

According to an exemplary embodiment, the rear panel assembly may comprise one or more protruding studs.

According to an exemplary embodiment, the two side panel assemblies may comprise one or more holes configured to receive the one or more protruding studs when the rear panel assembly is removably secured to the two side panel assemblies, causing the one or more studs to protrude through the one or more holes.

According to an exemplary embodiment, the modular canopy system may comprise one or more handles, each handle configured to connect to a stud protruding through the hole, locking the rear panel assembly to the two side panel assemblies.

According to an exemplary embodiment, the roof panel assembly may comprise one of more latching handles configured to lock the roof panel assembly to the two side panel assemblies and the rear panel assembly.

According to an exemplary embodiment, the roof panel assembly may comprise one or more guiding pins to aid in positioning the roof panel assembly over the two side panel assemblies and the rear panel assembly.

According to an exemplary embodiment, the modular canopy system may comprise the vehicle.

According to an object of the present disclosure, a method for assembling a modular canopy system is provided. The method may comprise installing two side panel assemblies along a vehicle, removably securing a rear panel assembly to the two side panel assemblies, and removably securing a roof panel assembly to the rear panel assembly and the two side panel assemblies, forming a canopy over a portion of the vehicle.

According to an exemplary embodiment, the installing the two side panel assemblies may comprise aligning each side panel assembly, using a bracket and one or more locating pins, with a receiving structure of the vehicle.

According to an exemplary embodiment, the removably securing the rear panel assembly to the two side panel assemblies may comprise inserting one or more studs of the rear panel assembly through one or more holes in the two side panel assemblies.

According to an exemplary embodiment, the removably securing the rear panel assembly to the two side panel assemblies may comprise connecting a handle to each stud protruding from each hole, locking the rear panel assembly to the two side panel assemblies.

According to an exemplary embodiment, the removably securing the roof panel assembly to the rear panel assembly and the two side panel assemblies may comprise rotating one or more latching handles of the roof panel assembly.

According to an exemplary embodiment, the removably securing the rear panel assembly to the two side panel assemblies may comprise interconnecting a magnetic locking system coupled to the rear panel assembly and the two side panel assemblies.

According to an exemplary embodiment, the magnetic locking system may comprise one or more: magnetic locating mechanisms; and one or more mounting plates.

According to an exemplary embodiment, the one or more magnetic locating mechanisms may comprise one or more magnets.

According to an exemplary embodiment, the one or more magnets may be attracted to the one or more mounting plates.

### BRIEF DESCRIPTION OF THE DRAWINGS

The accompanying drawings, which are incorporated in and form a part of the Detailed Description, illustrate various non-limiting and non-exhaustive embodiments of the subject matter and, together with the Detailed Description, serve to explain principles of the subject matter discussed below. Unless specifically noted, the drawings referred to in this Brief Description of Drawings should be understood as not being drawn to scale and like reference numerals refer to like parts throughout the various figures unless otherwise specified.

FIG. 1 illustrates a partially exploded perspective view of a vehicle comprising a modular canopy system, according to an exemplary embodiment of the present disclosure.

FIG. 2 illustrates a partially exploded perspective view of a vehicle comprising a modular canopy system, according to an exemplary embodiment of the present disclosure.

FIG. 3 illustrates a perspective view of a rear panel assembly of a modular canopy system, according to an exemplary embodiment of the present disclosure.

FIG. 4 illustrates a partially exploded perspective view of a vehicle comprising a side panel assembly of a modular canopy system, according to an exemplary embodiment of the present disclosure.

FIG. 5 illustrates a flowchart of a method for assembling a modular canopy system, according to an exemplary embodiment of the present disclosure.

FIG. 6 illustrates side panel assemblies being positioned on a vehicle, according to an exemplary embodiment of the present disclosure.

FIGS. 7A-7C illustrate a rear panel assembly being installed onto side panel assemblies, according to an exemplary embodiment of the present disclosure.

FIGS. 8A-8C illustrate a roof panel assembly being installed onto a rear panel assembly and side panel assemblies, according to an exemplary embodiment of the present disclosure.

### DETAILED DESCRIPTION

The following Detailed Description is merely provided by way of example and not of limitation.

Furthermore, there is no intention to be bound by any expressed or implied theory presented in the preceding background or in the following Detailed Description.

Reference will now be made in detail to various exemplary embodiments of the subject matter, examples of which are illustrated in the accompanying drawings. While various embodiments are discussed herein, it will be understood that they are not intended to limit to these embodiments.

On the contrary, the presented embodiments are intended to cover alternatives, modifications, and equivalents, which may be included within the spirit and scope of the various embodiments as defined by the appended claims. Furthermore, in this Detailed Description, numerous specific details are set forth in order to provide a thorough understanding of embodiments of the present subject matter. However, embodiments may be practiced without these specific details. In other instances, well known methods, procedures, components, and circuits have not been described in detail as not to unnecessarily obscure aspects of the described embodiments.

Some portions of the detailed descriptions which follow are presented in terms of procedures, logic blocks, processing, and other symbolic representations of operations on data within an electrical device. These descriptions and representations are the means used by those skilled in the data processing arts to most effectively convey the substance of their work to others skilled in the art.

In the present application, a procedure, logic block, process, or the like, is conceived to be one or more self-consistent procedures or instructions leading to a desired result. The procedures are those requiring physical manipulations of physical quantities. Usually, although not necessarily, these quantities may take the form of electrical or magnetic signals capable of being stored, transferred, combined, compared, and otherwise manipulated in an electronic system, device, and/or component.

It should be borne in mind, however, that these and similar terms are to be associated with the appropriate physical quantities and are merely convenient labels applied to these quantities.

Unless specifically stated otherwise as apparent from the following discussions, it is appreciated that throughout the description of embodiments, discussions utilizing terms such as “determining,” “communicating,” “taking,” “comparing,” “monitoring,” “calibrating,” “estimating,” “initiating,” “providing,” “receiving,” “controlling,” “transmitting,” “isolating,” “generating,” “aligning,” “synchronizing,” “identifying,” “maintaining,” “displaying,” “switching,” or the like, refer to the actions and processes of an electronic item such as: a processor, a sensor processing unit (SPU), a processor of a sensor processing unit, an application processor of an electronic device/system, or the like, or a combination thereof. The item manipulates and transforms data represented as physical (electronic and/or magnetic) quantities within the registers and memories into other data similarly represented as physical quantities within memories or registers or other such information storage, transmission, processing, or display components.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

In aspects, a vehicle may comprise an internal combustion engine system as disclosed herein.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise.

These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Embodiments described herein may be discussed in the general context of processor-executable instructions residing on some form of non-transitory processor-readable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

According to exemplary embodiments, a modular canopy assembly system is provided.

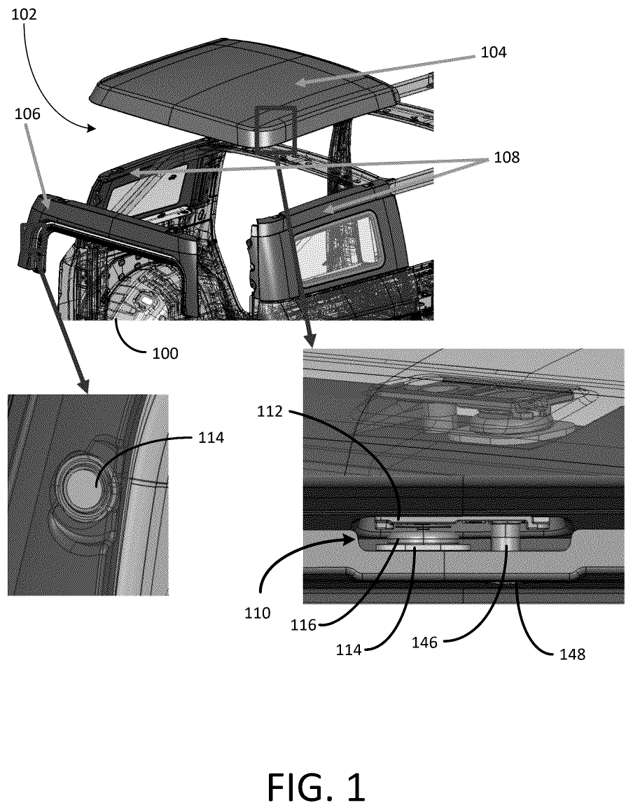

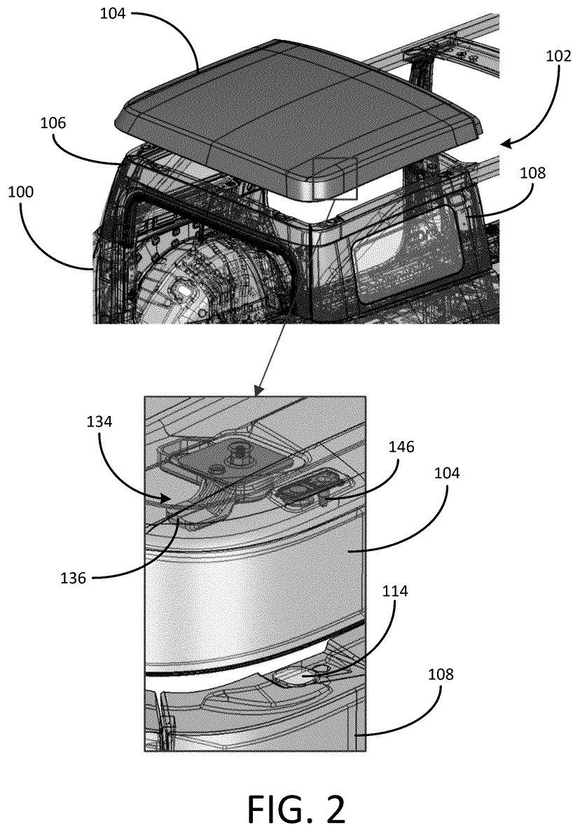

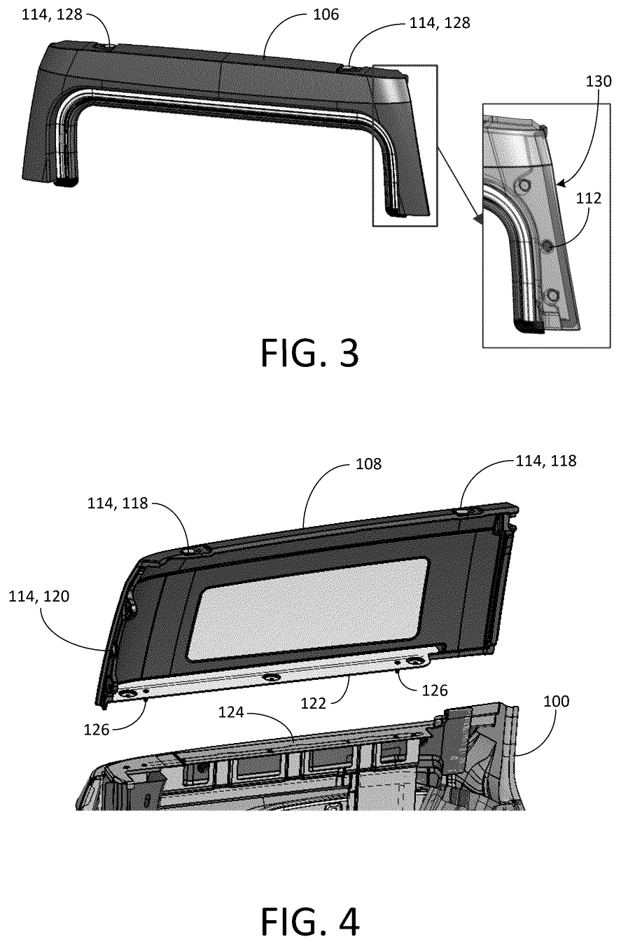

Referring now to FIG. 1, a perspective view of a vehicle 100 comprising a modular canopy system 102 (FIG. 1), a perspective view of a roof panel assembly 104 (FIG. 2), a perspective view of a rear panel assembly 106 (FIG. 3), and a perspective view of a side panel assembly 108 (FIG. 4) are illustratively depicted, in accordance with exemplary embodiments of the present disclosure. The vehicle 100 may comprise a sport utility vehicle (SUV) or other suitable vehicle type.

According to an exemplary embodiment, the modular canopy system 102 may comprise a roof panel assembly 104, a rear panel assembly 106, and one or more side panel assemblies 108.

According to an exemplary embodiment, the modular canopy system 102 may comprise four separate panels (the roof panel assembly 104, the rear panel assembly 106, and two side panel assemblies 108). It is noted, however, that the modular canopy system 102 may comprise greater or fewer panels, while maintaining the spirit and functionality of the present disclosure.

According to an exemplary embodiment, the modular canopy system 102 may be configured to be assembled to the vehicle 100 one panel at a time. The panels may be configured to be lightweight, allowing for one person to assemble and/or disassemble the modular canopy system 102.

According to an exemplary embodiment, the modular canopy system 102 may comprise an embedded magnetic locking system 110. The embedded magnetic locking system 110 may comprise one or more magnetic locating mechanisms 112 and one or more mounting plates 114 embedded into the modular canopy system 102. The one or more magnetic locating mechanisms 112 may each comprise one or more magnets 116. The mounting plates 114 may comprise steel, iron, and/or other suitable material configured to securing to the one or more magnets 116.

According to an exemplary embodiment, the one or more magnets 116 are attracted to the one or more mounting plates 114. A magnetic force between the one or more magnets 116 on the one or more magnetic locating mechanisms 112 and the one or more mounting plates 114 may be configured to hold each panel in a proper location while the user locks the panel into place without assistance.

According to an exemplary embodiment, each of the side panel assemblies 108 may comprise one or more roof mounting plates 118 and one or more rear mounting plates 120. According to an exemplary embodiment, each of the mounting plates 114 may be integrated into an edge of the side panel assembly 108.

According to an exemplary embodiment, each of the side panel assemblies 108 may comprise a bracket 122 configured to sit on a receiving structure 124 of the vehicle 100. According to an exemplary embodiment, the bracket 122 may comprise one or more locating pins 126 or other suitable device for properly positioning the side panel assembly 108 onto the vehicle 100.

According to an exemplary embodiment, the bracket 122 may be positioned on a bottom edge of the side panel assembly 108

According to an exemplary embodiment, the rear panel assembly 106 may comprise one or more roof mounting plates 128 and one or more magnetic locating mechanisms 112. The one or more roof mounting plates 128 may be positioned on a top edge of the rear panel assembly 106. The one or more magnetic locating mechanisms 112 may be positioned on each side of a front face 130 of the rear panel assembly 106. According to an exemplary embodiment, each of the mounting plates 114 may be integrated into an edge of the rear panel assembly 106.

According to an exemplary embodiment, the roof panel assembly 104 may comprise a plurality of magnetic location mechanisms 112 comprising one or more magnets 116. The one or more magnetic location mechanisms 112 of the roof panel assembly 104 may be positioned along a bottom face 132 of the roof panel assembly 104. The one or more magnets 116 of the plurality of magnetic location mechanisms 112 of the roof panel assembly 104 may be configured to interact with the one or more roof mounting plates 118 of the side panel assemblies 108 and the one or more roof mounting plates 128 of the rear panel assembly 106, securing the roof panel assembly 104 to the side panel assemblies 108 and the rear panel assembly 106 while the user locks the roof panel assembly 104 into place without assistance.

According to an exemplary embodiment, the modular canopy system 102 may comprise one or more locking mechanisms 134 configured to secure a panel to another panel. For example, as shown in FIG. 2, the roof panel assembly 104 may comprise one or more latching handles 136.

Each of the one or more latching handles 136 may be configured to be secure to, and slide within, one or more receiving areas 138. The one or more receiving areas 138 may be positioned along a top surface of one or more side panel assemblies 108 and/or the roof panel assembly 106.

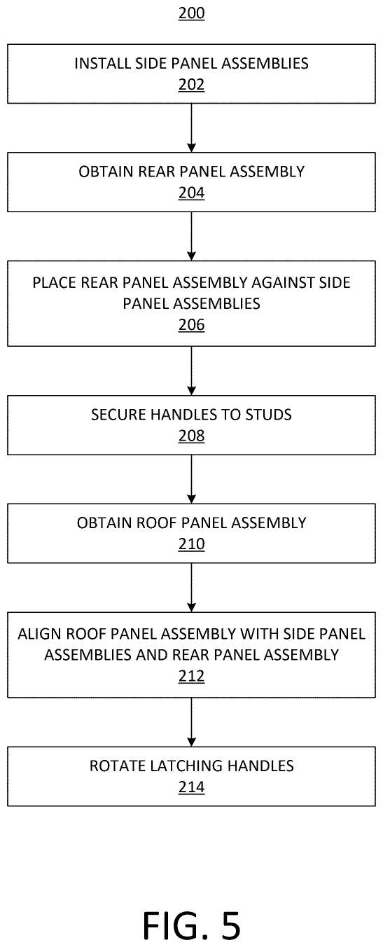

Referring now to FIG. 5, a flowchart of a method 200 for assembling the modular canopy system 102 is illustratively depicted, in accordance with an exemplary embodiment of the present disclosure.

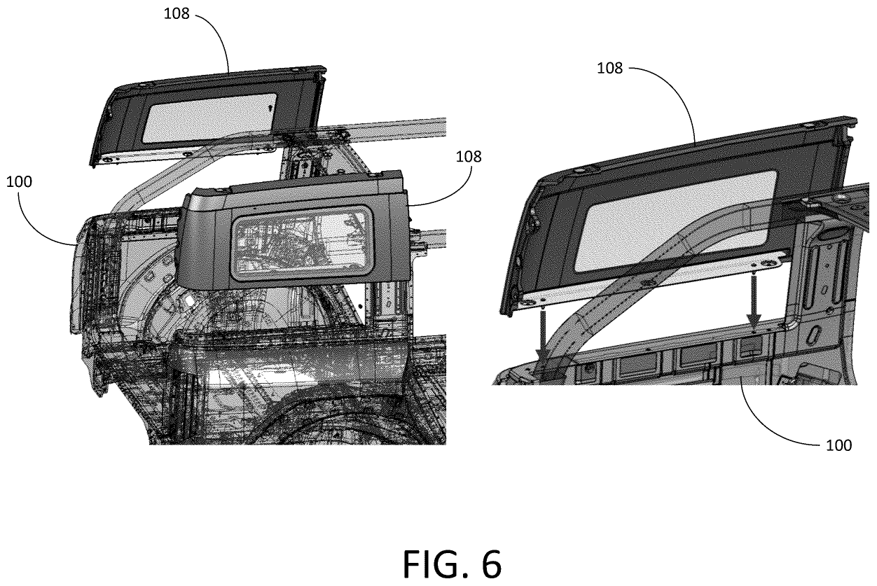

At 202, the user may install the side panel assemblies 108 onto the vehicle 100, as shown, e.g., in FIG. 6. Installing the side panel assemblies 108 onto the vehicle 100 may comprise aligning each side panel assembly 108, using the locating pins 126, and positioning the brackets 122 on their respective receiving structures on the vehicle 100. According to an exemplary embodiment, installing the side panel assemblies 108 may comprise fastening each side panel assembly 108 on to the vehicle 100. This may be done via screws, bolts, latches, and/or other suitable mechanisms.

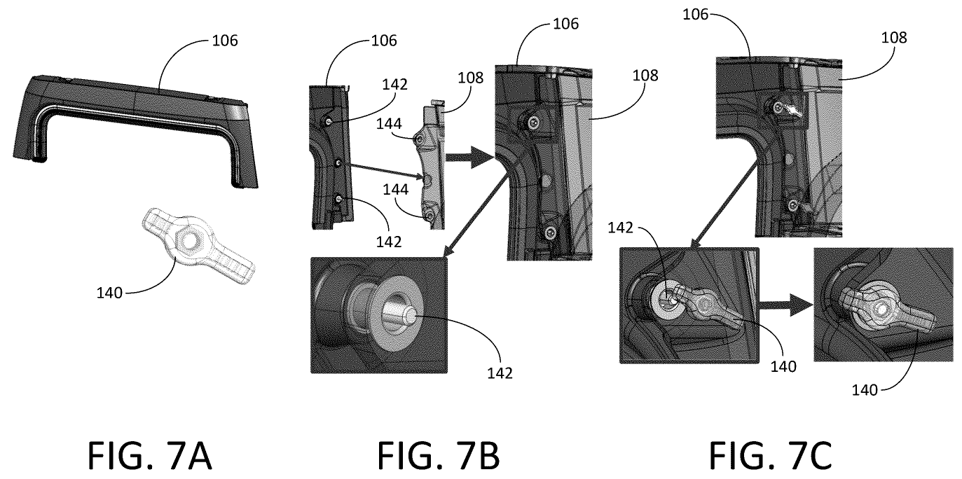

At 204, the user may obtain the rear panel assembly 106 and one or more rear handles 140, as shown, e.g., in FIG. 7A. According to an exemplary embodiment, the user may obtain four rear handles 140. It is noted, however, that other quantities of rear handles 140 may be incorporated while maintaining the spirit and functionality of the present disclosure.

At 206, the user may place the rear panel assembly 106 against the side panel assemblies 108, as shown, e.g., in FIG. 7B. According to an exemplary embodiment, placing the rear panel assembly 106 against the side panel assemblies 108 may comprise placing the one or more magnetic locating mechanisms 112 of the rear panel assembly 106 against the one or more rear mounting plates 120 of the side panel assemblies 108.

According to an exemplary embodiment, the rear panel assembly 106 may comprise one or more protruding studs 142 and the rear panel assemblies 108 may comprise one or more holes 144 configured to receive the one or more studs 142. When the rear panel assembly 106 is placed against the side panel assemblies 108, the one or more studs 142 protrude from the one or more holes 144, as shown, e.g., in FIG. 7C. At 208, when the one or more studs 142 are protruding through the one or more holes 144, the one or more handles 140 are each secured to a stud 142, securing the rear panel assembly 106 in place in relation to the side panel assemblies 108 and the vehicle 100, as shown, e.g., in FIG. 7C.

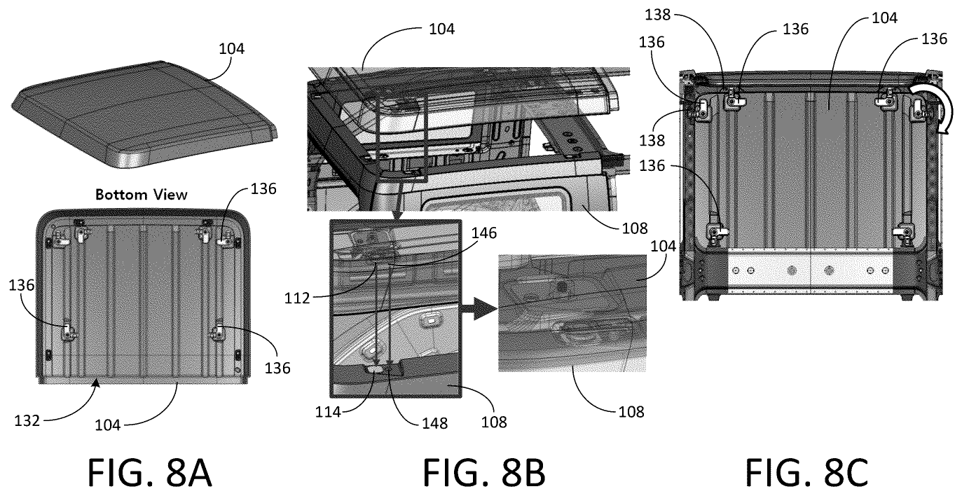

At 210, the user may obtain the roof panel assembly 104, as shown, e.g., in perspective view and bottom view in FIG. 8A. According to an exemplary embodiment, prior to assembly, the one or more latching handles 136 of the roof panel assembly 104 should be in an open position, as shown, e.g., in FIG. 8A.

According to an exemplary embodiment, the roof panel assembly 104 may comprise one or more guide pins 146 configured to align with one or more holes 148 in the one or more side panel assemblies 108 and/or the rear panel assembly 106 when the roof panel assembly 104 is aligned with the one or more side panel assemblies 108 and the rear panel assembly 106. The one ore more guide pins 146 may be configured to aid in positioning the roof panel assembly 104 over the rear panel assembly 106 and the side panel assemblies 108. At 212, the roof panel assembly 104 may be aligned with the one or more side panel assemblies 108 and the rear panel assembly 106, using the one or more pins 146 and the one or more holes 148, as shown, e.g., in FIG. 8B.

According to an exemplary embodiment, the plurality of magnetic location mechanisms 112 comprising one or more magnets 116 may be configured to interact with the one or more roof mounting plates 118 of the side panel assemblies 108 and the one or more roof mounting plates 128 of the rear panel assembly 106, securing the roof panel assembly 104 to the side panel assemblies 108 and the rear panel assembly 106. At 214, the one or more latching handles 136 of the roof panel assembly 104 may be rotated into a locking position within the one or more receiving areas 138, as shown, e.g., in FIG. 8C, completing assembly of the modular canopy system 102. According to an exemplary embodiment, the one or more latching handles 136 may be configured to pivot 90 degrees into the locking position. It is noted, however, that other degrees of pivot may be incorporated, while maintaining the spirit and functionality of the present disclosure.

According to an exemplary embodiment, each of the panels may be configured to latch onto one or more other panels and/or to the vehicle 100 itself.

According to an exemplary embodiment, the modular canopy system 102 may be configured to be secured to a rear of the vehicle 100, a front of the vehicle 100, and/or other suitable position along the vehicle 100.

According to an exemplary embodiment, the roof panel assembly 104, the rear panel assembly 106, and the plurality of side panel assemblies 108 are configured to be removably secured to the vehicle 100 and/or each other.

What has been described above includes examples of the subject disclosure. It is, of course, not possible to describe every conceivable combination of components or methodologies for purposes of describing the subject matter, but it is to be appreciated that many further combinations and permutations of the subject disclosure are possible. Accordingly, the claimed subject matter is intended to embrace all such alterations, modifications, and variations that fall within the spirit and scope of the appended claims.

In particular and in regard to the various functions performed by the above described components, devices, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter.

The aforementioned systems and components have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components. Any components described herein may also interact with one or more other components not specifically described herein.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

Thus, the embodiments and examples set forth herein were presented in order to best explain various selected embodiments of the present invention and its particular application and to thereby enable those skilled in the art to make and use embodiments of the invention. However, those skilled in the art will recognize that the foregoing description and examples have been presented for the purposes of illustration and example only. The description as set forth is not intended to be exhaustive or to limit the embodiments of the invention to the precise form disclosed.

What is claimed is:

1. A modular canopy system, comprising:
a roof panel assembly;
a rear panel assembly; and
two side panel assemblies,
wherein:
the two side panel assemblies are configured to be removably secured to a vehicle;
the rear panel assembly is configured to be removably secured to the two side panel assemblies,
the roof panel assembly is configured to be removably secured to the two side panel assemblies and the rear panel assembly, forming a canopy over a portion of the vehicle.

2. The modular canopy system of claim 1, further comprising a magnetic locking system,
wherein the roof panel assembly is configured to be removably secured to the two side panel assemblies and the rear panel assembly via the magnetic locking system.

3. The modular canopy system of claim 2, wherein the magnetic locking system comprises one or more:
magnetic locating mechanisms; and
one or more mounting plates.

4. The modular canopy system of claim 3, wherein the one or more magnetic locating mechanisms comprise one or more magnets.

5. The modular canopy system of claim 4, wherein the one or more magnets are attracted to the one or more mounting plates.

6. The modular canopy system of claim 1, wherein the rear panel assembly comprises one or more protruding studs.

7. The modular canopy system of claim 6, wherein the two side panel assemblies comprise one or more holes configured to receive the one or more protruding studs when the rear panel assembly is removably secured to the two side panel assemblies, causing the one or more studs to protrude through the one or more holes.

8. The modular canopy system of claim 6, further comprising one or more handles, each handle configured to connect to a stud protruding through the hole, locking the rear panel assembly to the two side panel assemblies.

9. The modular canopy system of claim 1, wherein the roof panel assembly comprises one of more latching handles configured to lock the roof panel assembly to the two side panel assemblies and the rear panel assembly.

10. The modular canopy system of claim 1, wherein the roof panel assembly comprises one or more guiding pins to aid in positioning the roof panel assembly over the two side panel assemblies and the rear panel assembly.

11. The modular canopy system of claim 1, further comprising the vehicle.

12. A method for assembling a modular canopy system, comprising:
installing two side panel assemblies along a vehicle;
removably securing a rear panel assembly to the two side panel assemblies; and
removably securing a roof panel assembly to the rear panel assembly and the two side panel assemblies, forming a canopy over a portion of the vehicle.

13. The method of claim 12, wherein the installing the two side panel assemblies comprises:
aligning each side panel assembly, using a bracket and one or more locating pins, with a receiving structure of the vehicle.

14. The method of claim 12, wherein the removably securing the rear panel assembly to the two side panel assemblies comprises:
inserting one or more studs of the rear panel assembly through one or more holes in the two side panel assemblies.

15. The method of claim 14, wherein the removably securing the rear panel assembly to the two side panel assemblies comprises:
connecting a handle to each stud protruding from each hole, locking the rear panel assembly to the two side panel assemblies.

16. The method of claim 12, wherein the removably securing the roof panel assembly to the rear panel assembly and the two side panel assemblies comprises rotating one or more latching handles of the roof panel assembly.

17. The method of claim 12, wherein the removably securing the rear panel assembly to the two side panel assemblies comprises interconnecting a magnetic locking system coupled to the rear panel assembly and the two side panel assemblies.

18. The method of claim 17, wherein the magnetic locking system comprises one or more:
magnetic locating mechanisms; and
one or more mounting plates.

19. The method of claim 18, wherein the one or more magnetic locating mechanisms comprise one or more magnets.

20. The method of claim 19, wherein the one or more magnets are attracted to the one or more mounting plates.
